(19) United States
(12) Patent Application Publication
(10) Pub. No.: US 2016/0098160 A1
(43) Pub. Date: Apr. 7, 2016

(54) SENSOR-BASED INPUT SYSTEM FOR MOBILE DEVICES

(71) Applicant: Erik Groset, Carlsbad, CA (US)

(72) Inventor: Erik Groset, Carlsbad, CA (US)

(21) Appl. No.: 14/875,563

(22) Filed: Oct. 5, 2015

Related U.S. Application Data
(60) Provisional application No. 62/059,887, filed on Oct. 4, 2014.

(51) Int. Cl. G06F 3/0482; H04N 5/232; G06F 3/00; G06F 3/01; G06F 1/16

(52) U.S. Cl. CPC G06F 3/0482; G06F 3/017; G06F 1/163; G06F 3/005; H04N 5/23229; G06F 3/013

(57) ABSTRACT

A graphical user interface is displayed on a device display of a mobile device, by at least one data processor executing a display engine. The graphical user interface includes a first set of user-input elements capable of receiving user input defining a command to be performed by the mobile device. The display engine, executed by a data processor, receives sensor data from a sensor operatively connected to the mobile device. The sensor data corresponds to a user motion that is detected by the at least one sensor. The display engine, executed by a data processor, determines, based on the received sensor data, a second set of user-input elements to display on the graphical user interface. The second set of user-input elements is displayed on the graphical user interface by the display engine.

### CROSS-REFERENCE TO RELATED APPLICATIONS

The current application is related to/claims priority under 35 U.S.C. §119(e) to provisional patent application 62/059,887 filed Oct. 4, 2014, the contents of which are incorporated by reference in its entirety.

### TECHNICAL FIELD

The subject matter described herein relates to displaying an input system on a mobile device, in particular, to generating and displaying input systems in response to data from sensors in a mobile device.

### BACKGROUND

Mobile devices, in particular, smartphones, smart watches, or the like, use touch-screen displays that allow a user to enter data or other commands. A common application on mobile devices is displaying images that render a full keyboard on the screen of a mobile device. A user can “tap” or type on the rendered keyboard similar to typing on a real keyboard. The size of the individual “keys” displayed allows a replica of a full keyboard to appear on the screen. Typically, the full keyboard contains at least three rows of keys, with buttons that allow the user to access other keys (such as numbers) or other features (such as emoji or icons). Whatever space is left on the screen is generally allocated to displaying the message as it is typed by the user or displaying a history of sent and received messages.

### SUMMARY

In one aspect, a graphical user interface is displayed on a device display of a mobile device, by at least one data processor executing a display engine. The graphical user interface includes a first set of user-input elements capable of receiving user input defining a command to be performed by the mobile device. The display engine, executed by a data processor, receives sensor data from a sensor operatively connected to the mobile device. The sensor data corresponds to a user motion that is detected by the at least one sensor. The display engine, executed by a data processor, determines, based on the received sensor data, a second set of user-input elements to display on the graphical user interface. The second set of user-input elements is displayed on the graphical user interface by the display engine.

In a related aspect, a graphical user interface is displayed on a device display of a mobile device, by at least one data processor executing a display engine. The graphical user interface includes a first set of user-input elements capable of receiving user input defining a command to be performed by the mobile device. The display engine, executed by a data processor, receives sensor data from a sensor operatively connected to the mobile device. The sensor data is capable of corresponding to a user motion that is detected by the at least one sensor. The display engine, executed by a data processor, determines, based on the received sensor data, a second set of user-input elements to display on the graphical user interface. The second set of user-input elements is displayed on the graphical user interface by the display engine.

In some variations one or more of the following features can optionally be included in any feasible combination.

The received sensor data can be based on device motion detected by the sensor and corresponding to the user motion. The device motion can include a rotational motion corresponding to a device rotation about an axis. The device motion further can also include an angular acceleration about the axis. The determining can be further based on a value of the angular acceleration, determined from the received sensor data, exceeding a predetermined threshold.

The mobile device can be a wearable device worn by a user. Also, the wearable device can be a smart watch worn on a wrist of the user with the axis proximate to a center of the wrist and substantially parallel with a forearm of a user.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a sensor-based input system for mobile devices, it should be readily understood that such features are not intended to be limiting.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating user-interface elements in a graphical user interface displayed on a device display of a mobile device;

FIG. 2 is a diagram illustrating the user-interface elements updated in response to received sensor data;

FIG. 3 is a diagram illustrating a mapping of user-interface elements that can be displayed in the GUI of the mobile device;

FIG. 4 is a diagram illustrating one implementation of the mobile device where the mobile device is a smart watch;

FIG. 5 is a diagram illustrating user-interface elements updated in response to a motion by a user;

FIG. 6 is a diagram illustrating the mobile device where two rows of user-interface elements are displayed on the graphical user interface;

FIG. 7 is a diagram illustrating the user-interface elements updated in response to a lateral motion by a user; and

FIG. 8 is a process flow diagram illustrating the displaying of user-input elements on a mobile device in response to received sensor data.

When practical, similar reference numbers denote similar structures, features, or elements.

### DETAILED DESCRIPTION

The details of one or more variations of the subject matter described herein are set forth in the accompanying drawings and the description below. Other features and advantages of the subject matter described herein will be apparent from the description and drawings. While certain features of the currently disclosed subject matter may be described for illustrative purposes in relation to providing sensor-based input systems for mobile devices, it should be readily understood that such features are not intended to be limiting. The claims that follow this disclosure are intended to define the scope of the protected subject matter.

As used herein, the term “mobile devices” can include, for example, smart phones, smart watches, smart glasses, tablet computers, personal data assistants, or the like.

Also, as used herein, the term “user-input elements” can include displayed elements allowing a user to input data or commands to the mobile device, for example, keys mimicking those found on a traditional computer keyboard, icons, emoji, special characters, pictures, text items, or the like. The user-input elements can be, for example, displayed on capacitive touch-based display screen of the type found on smart phones, smart watches, or the like.

The present application describes implementations that can include enabling a mobile device to leverage data from onboard sensors to display or update displayed user-input elements on a display screen of the mobile device. The sensor data can be received from sensors that detect the motion of the mobile device when held or worn by a user. The displaying or updating of the user-input elements can be based on received sensor data. The sensor data can be interpreted as a command to show a different portion or selection of user-interface elements. By using motions to select what elements are displayed, a smaller number of visually larger user-interface elements can be shown as opposed to showing a large number of smaller user-interface elements.

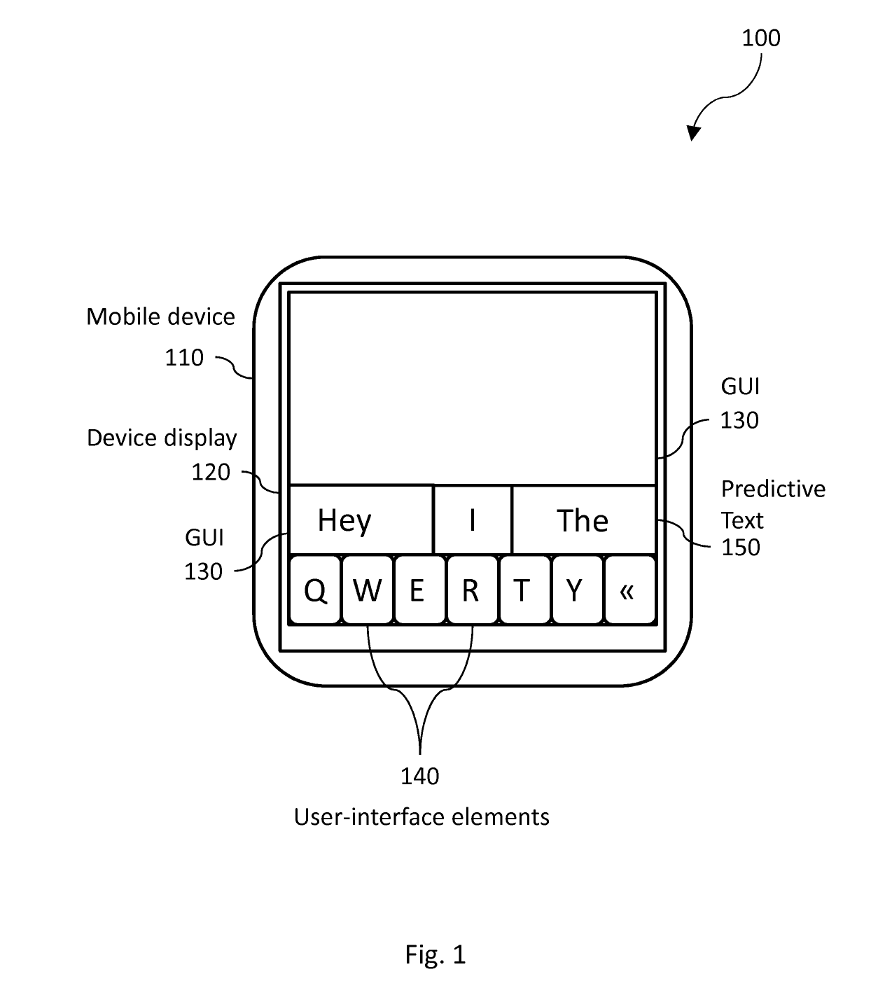

FIG. 1 is a diagram 100 illustrating user-interface elements 140 in a graphical user interface displayed on a device display 120 of a mobile device 110. As described above, the mobile device 110 can be, for example, a smart phone or a smart watch. The mobile device 110 can have a device display 120, or screen, which renders images such as text, pictures, icons, or the like. The images can be rendered in a graphical-user interface (GUI) 130 of the device display 120. The GUI 130 can include any number of user-interface elements 140 that the user can interact with in order to enter data or commands to the mobile device 110. Optionally, there can be auto-predictive text software that displays textual options 150 that the user can select for inclusion in a message. As shown in FIG. 1, the user-interface elements 140 can include a row of images representing keys from a keyboard. Here, the letters “Q,” “W,” “E,” “R,” “T,” and “Y” are shown. Also shown is a user-interface element corresponding to a backspace key. The partial replication of the keyboard shown can result in user-interface elements 140 larger than would be displayed if an entire standard keyboard was displayed. Therefore, correspondingly more room can be available in the remainder of the GUI 130 for the display of other images or text.

The mobile device 110 can also include sensors that can detect the motion and/or orientation of the mobile device 110. These sensors can include, for example, accelerometers, cameras, gyroscopes, barometers, microphones, or the like. The sensors can be sensitive to changes in linear position, angular position, linear or angular accelerations, impulses, or the like. In the case of cameras, the sensor data can be associated with imaged movement, for example, of a user's eye, head, mouth, or the like. The sensors can generate electrical signals that are converted to sensor data and made available to applications running on the mobile device 110. The sensor data can also be synchronized with a clock on the mobile device 110 to provide a time base for the sensor data.

A computer program, for example a display engine, can be executed by the mobile device 110 to determine what user-interface elements 140 to display on the GUI 130. The display engine can display a first set of user-interface elements 140 in a GUI 130 on the device display 120 of the mobile device 110. The first set of user-interface elements 140 can receive user input that defines a command to be performed by the mobile device 110. The user input can include, for example, tapping, typing, pressing, swiping, or the like. The commands can be, for example, entering letters selected by a user into a text field, selecting menu options, moving images or text around on the GUI 130, or the like. In addition to the user-interface elements 140, the display engine can display graphical elements on the GUI 130 that do not accept user input, for example, decorative elements, non-interactive images, or the like.

The display engine can also receive data corresponding to the type of mobile device 110, user-preferences, and so on. Based on this additional data, the display engine can select the appearance and functionality of the user-interface elements 140 displayed in the GUI 130. For example, the user-interface elements may appear differently on different device display 120 sizes, different types of mobile devices, etc.

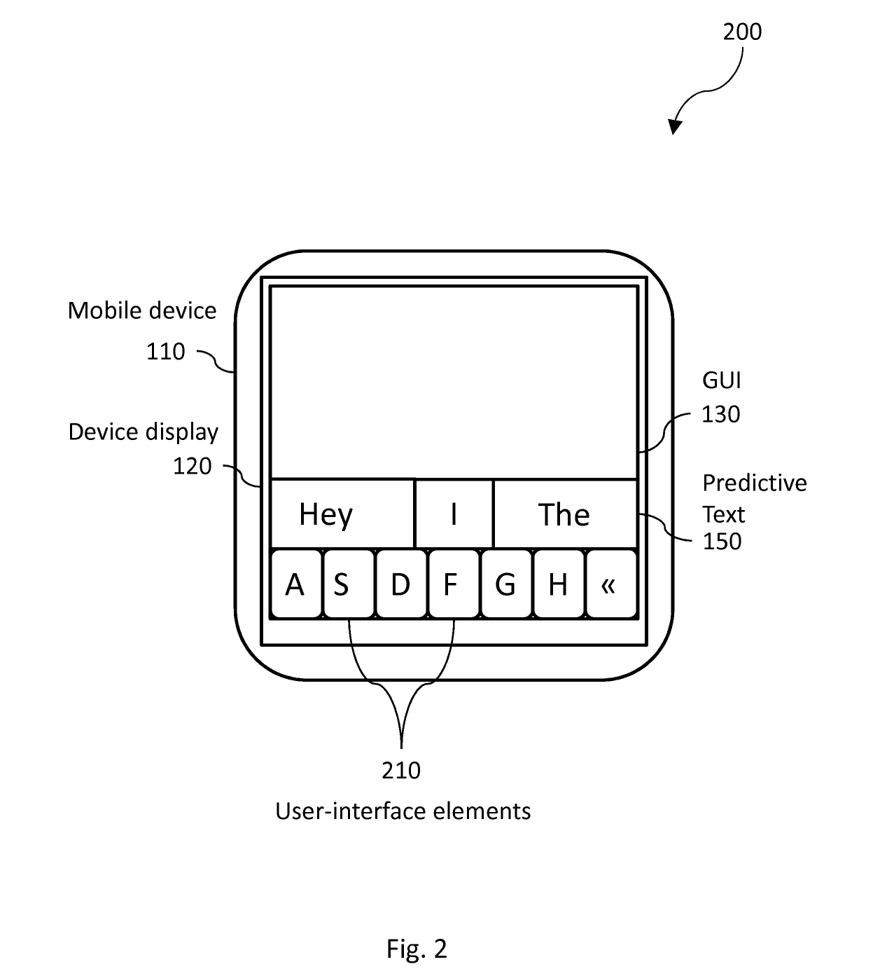

FIG. 2 is a diagram 200 illustrating the user-interface elements 210 updated in response to received sensor data. The display engine can receive sensor data from any of the sensors in the mobile device 110. Once received, the sensor data can be used to determine a second set of user-input elements 210 to display on the GUI 130. The second set of user-interface elements 210 can have a different appearance and/or functionality than the first set of user-interface elements 140. For example, the first set of user-interface elements 140, functioning as keys for typing, can be replaced by the second set of user-interface elements 210. The second set of user-interface elements 210 can function as a different set of keys for typing.

The sensor data can correspond to a user motion or a device motion, for example, a “twitch” of the mobile device 110, a “swipe” by a finger of a user or by a stylus on the device display 120, or the like.

As used herein, a “twitch” refers to an acceleration or an impulsive motion of the device display 120. A twitch can be a linear motion, a rotational motion about an axis, or a combination of the two. One example of a “twitch” can be a user holding the mobile device 110, such as a smart phone, and quickly rotating it from a first position to a second position. Another example of a “twitch” can be a user wearing a smart watch and quickly rotating their wrist or forearm to rotate the mobile device 110 about an axis. In this example, the axis can be proximate to the center of the wrist and substantially parallel to the forearm.

Also, as used herein, a “swipe” can include any kind of lateral or horizontal motion of the mobile device 110. A swipe can also include detected user motion, for example, a finger or other implement interacting with the device display 120, moving an eye left to right or vice versa as the eye is imaged by a sensor, or the like.

The sensor data received by the display engine can be analyzed by the display engine to determine if a change should be made to the GUI 130 and if so, what should be displayed. In one implementation, the determination can involve derivative analysis of the recorded sensor data. For example, the sensor data can determine a position of the sensor (and hence the mobile device 110). The velocity (first derivative of position) and/or acceleration (second derivative of position) can be measured directly or calculated from lower-order measurements. Similarly, the jerk (third derivative of position) can be calculated from the sensor data or measured directly. The analysis can be extended to higher-order derivatives with no loss of generality.

In some implementations, these quantities can be compared against a predetermined threshold. If the predetermined threshold is met, or exceeded, by the received sensor data, then the display engine can execute instructions to display the second set of user-interface elements 210 in the GUI 130. Such a determination can be used to discriminate between normal or incidental motion of the display device and motions that are intended to cause a desired change in the displayed user-interface elements. Pattern recognition of the sensor data can also be used to provide more accurate responses. For example, unintentionally, a predetermined value for the acceleration may be exceeded by dropping the mobile device 110 or other user motions. However, the sensor data, partially, or as a whole, can be compared to established ranges for acceptable sensor data that corresponds to a particular command to change the user-interface elements 140. The acceptable sensor data can define a curve, for example an acceleration curve, which describes a “twitch.” A library or other data store of characteristic motions that correspond to a desired change in the user-interface elements 140 can be stored in a memory of the mobile device 110, downloaded to the mobile device 110, generated by the user or “trained,” or any combination thereof. Similarly, the acceptable sensor data and/or the predetermined threshold can include tolerances to define an acceptable window of variation that still indicates a command to change the user-interface elements 140.

As described above, the display engine can determine, based on the received sensor data that the GUI 130 is to be updated. Then, the display engine can display, or transmit instructions to other components of the mobile device 110 to cause the displaying of the second set of user-interface elements 210 in the GUI 130. Optionally, the display engine can interpret the received sensor data as a command. For example, in response to a twitch, swipe, or other motion, a space can be inserted into a line of text, a return can be entered, or the like.

In the implementation shown in FIG. 2, the user-interface elements 210 are now shown as a portion of second row of a standard “querty” keyboard. For example, the letters “A,” “S,” “D,” “F,” “G,” and “H” can be displayed. In another implementation, one or more of the user-interface elements 140 can be manipulated according to the received sensor data. The manipulation can include, for example, translating, rotating, zooming, mirroring, or the like.

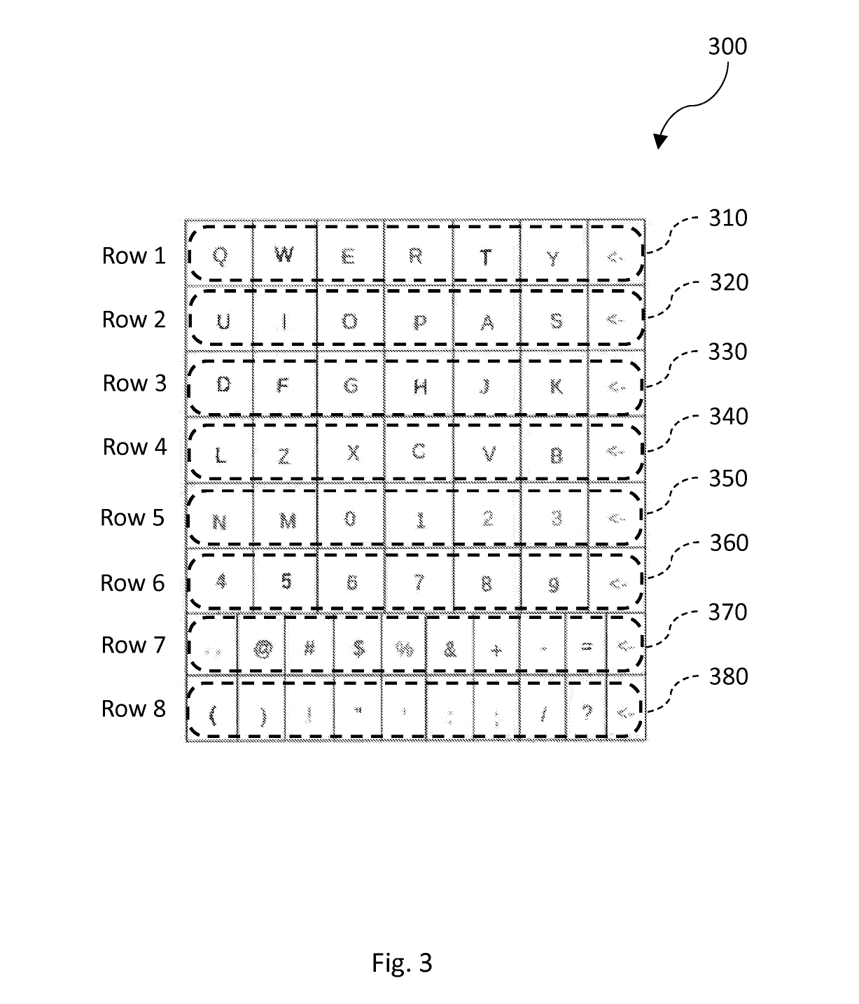

FIG. 3 is a diagram 300 illustrating a mapping of user-interface elements that can be displayed in the GUI 130 of the mobile device 110. The mapping can determine what set of user-interface elements to currently display in the GUI 130. The mapping can also determine what other set of user-interface elements are to be displaced based on the sensor data received by the display engine. In one implementation, shown in FIG. 3, the mapping can be a collection of rows 310-380, that correspond to a set of user-interface elements to be displayed on the GUI 130. For example, initially row 1 can be displayed in the GUI 130 to show the user-interface elements 310. In response to received sensor data, the display engine can determine that the next row down, row 2 should be displayed. The user-interface elements 320 can then be rendered to replace the user-interface elements 310 in the GUI 130.

The process of navigating the mapping using sensor data based on device motion can be bi-directional. In one example, user-interface elements 340 can be currently displayed on the GUI 130. Then, if a “twitch” was detected that corresponded to a rotation of the mobile device 110 away from the user, the user-interface elements 340 can be replaced by the user-interface elements 350. If an opposite twitch, such as one rotating the mobile device 110 towards the user, was detected then the mapping can be navigated in the opposite direction to replace user-interface elements 350 with user-interface elements 340 on the GUI 130. In this way, a series of twitches, swipes, or other motions of the mobile device 110 can be used to navigate the mapping and determine what user-interface elements to display in the GUI 130. Also as shown in FIG. 3, the number of user-interface elements can vary according to the mapping implemented by the display engine. In the example of FIG. 3, the last two rows have more user-interface elements than the others. The size of the user-interface elements displayed in the GUI 130 can be dependent on the number of user-interface elements, independent of the number of user-interface elements (for example by adding or eliminating space between user-interface elements), or predefined according to a second mapping. Again, the mapping implemented by the display engine can be device and/or application specific.

In another implementation, a swiping action, or any other specified user motion or device motion, can result in a horizontal scrolling across a predefined set of user-interface elements. Optionally, the swiping action can be interpreted by the display engine as instruction to execute displaying the next row in the mapping, similar to that done in response to a “twitch.”

The specific examples given herein are not intended to be limiting or exclusory. There can be many equivalent mappings of device motions or detected user motions to a set of user-interface elements to be displayed in the GUI 130.

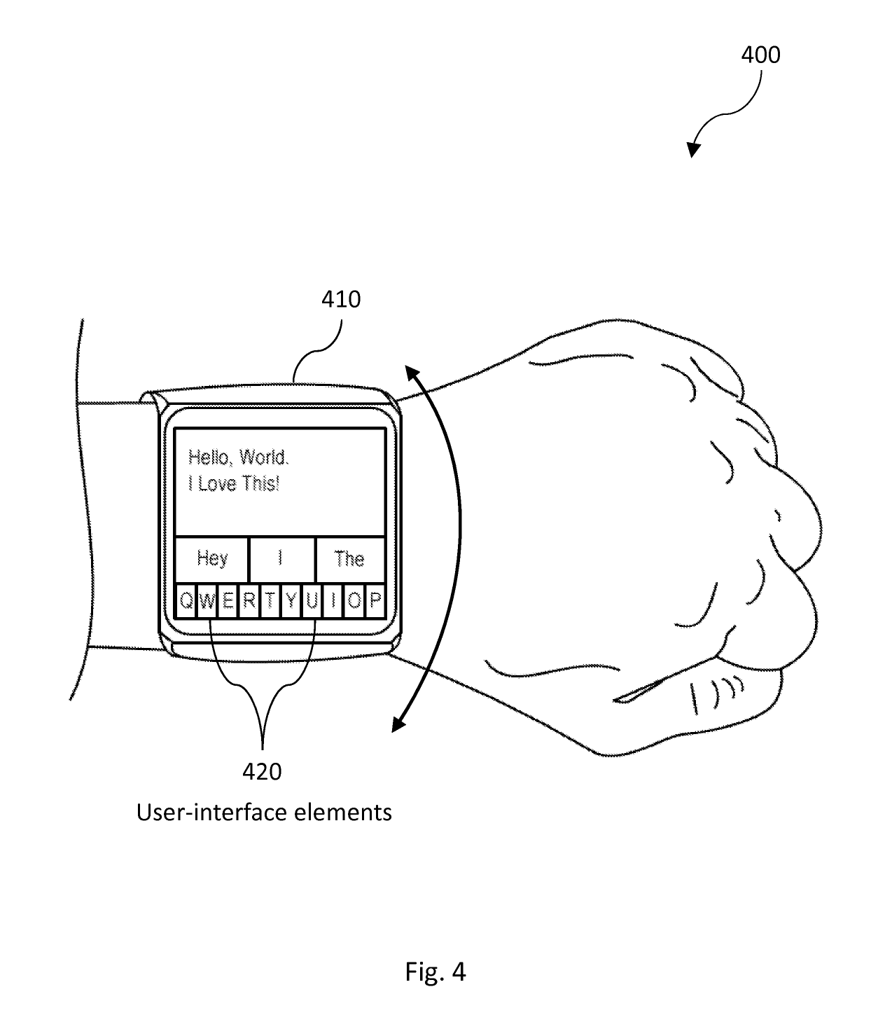

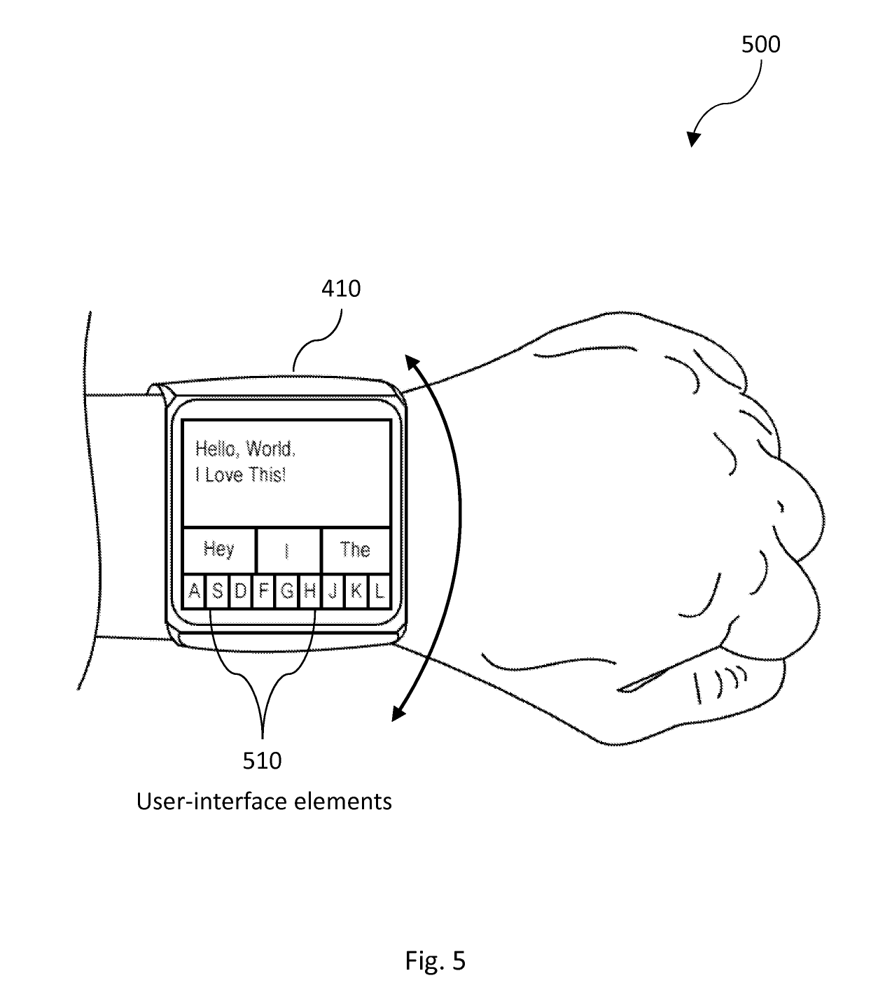

FIG. 4 is a diagram 400 illustrating one implementation of the mobile device 410 where the mobile device 410 is a smart watch. FIG. 5 is a diagram 500 illustrating user-interface elements 510 updated in response to a motion by a user. In this implementation, a first set of user-interface elements 420 is shown on a GUI 130 displayed on a device display 120 of a smart watch. Here, user-interface elements 420 are shown that correspond to a top portion of a standard “querty” keyboard. A portion of the remainder of the device display 120 can, for example, be utilized to display sent or received messages, characters or text as it is typed by the user, or the like.

In the implementation of FIG. 4, the user can “twitch” their wrist in a rotational motion as shown by the arrows. The rotation of the mobile device 110 can be detected by the sensors. The sensor data generated by the sensors can then be received by the display engine. The sensor data can then be interpreted, by the display engine, to determine that a second set of user-interface elements 510 is to be displayed, as shown in FIG. 5. Here, the second set of user-interface elements 510 correspond to another, different, row or partial row of keys from a “querty” keyboard.

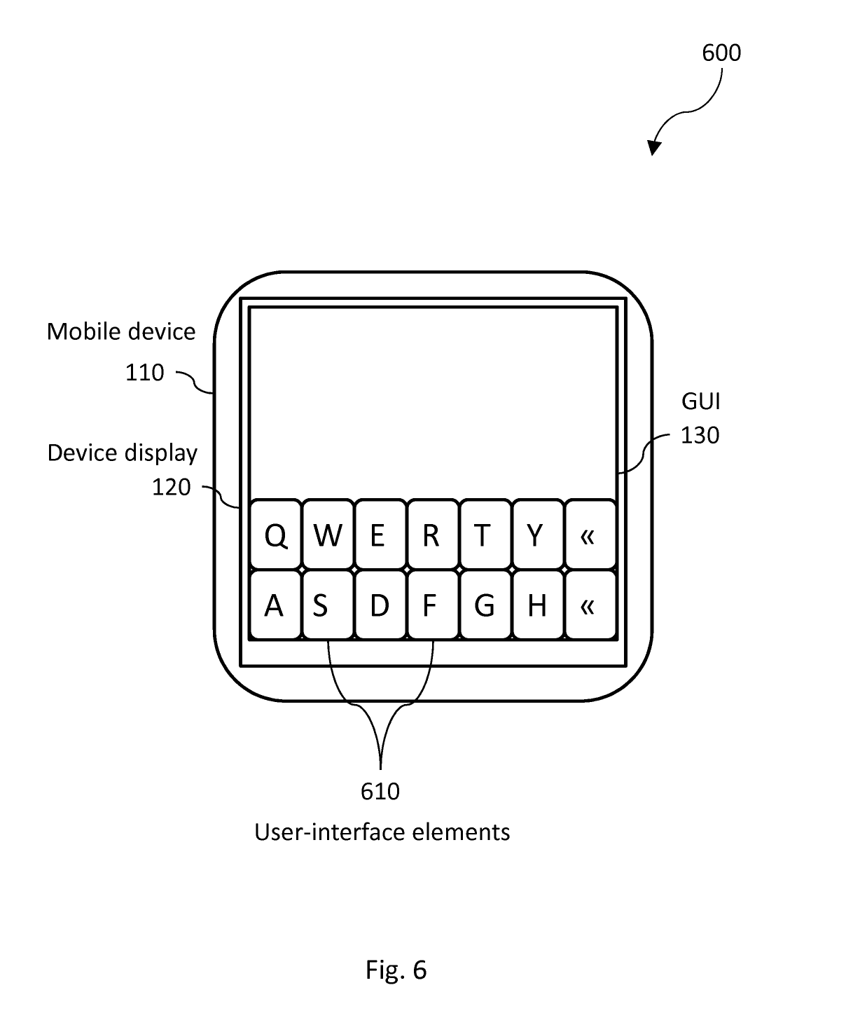

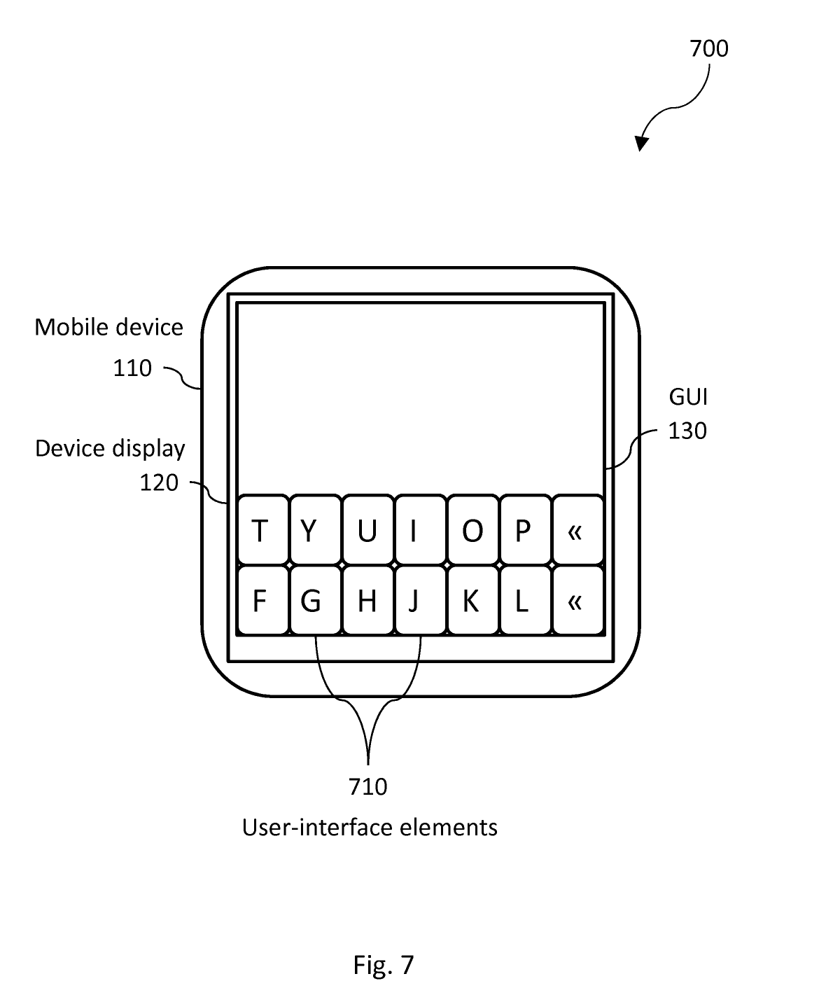

FIG. 6 is a diagram 600 illustrating the mobile device 110 where two rows of user-interface elements 610 are displayed on the graphical user interface 130. FIG. 7 is a diagram 700 illustrating the user-interface elements 710 updated in response to a lateral motion by a user. The implementation illustrated in FIG. 6 is similar to that described above and can include any of the features therein. In this implementation, instead of a single row of user-interface elements being displayed, two rows, a first row and a second row, are displayed. Sensor data can be received by the device engine and, for example, cause both displayed rows of user-interface elements 610 to be updated. One example of the updating is shown in FIG. 7 where, based on the received sensor data, the first set of user-interface elements 610 have been updated to a second set of user-interface elements 710, simulating a horizontal scrolling over a portion of a keyboard. The updating can be in response to any detected and specified motion, for example, a swipe, a twitch, or the like.

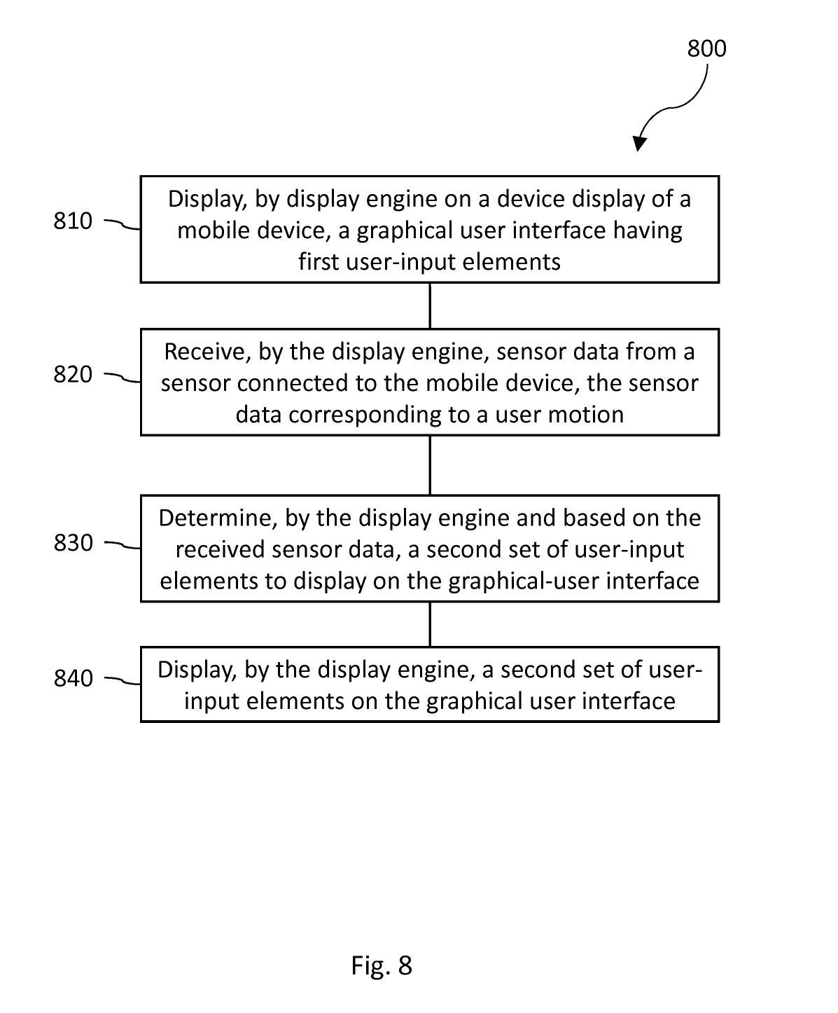

FIG. 8 is a process flow diagram illustrating the displaying of user-input elements on a mobile device 110 in response to received sensor data.

At 810, at least one data processor executing a display engine can display, on a device display 120 of a mobile device 110, a graphical user interface including a first set of user-input elements capable of receiving a user input defining to a command to be performed by the mobile device 110.

At 820, at least one data processor executing the display engine can receive sensor data from at least one sensor operatively connected to the mobile device 110. The sensor data can correspond to a user motion detected by the at least one sensor.

At 830, at least one data processor executing the display engine can determine, based on the received sensor data, a second set of user-input elements to display on the graphical user interface.

At 840, at least one data processor executing the display engine can display the second set of user-input elements on the graphical user interface.

Because of the high-level nature and complexity of the selections and methods described herein, including the multiple and varied combinations of different calculations, computations and selections, such selections and methods cannot be done in real time quickly or at all by a human. The processes described herein rely on the machines described herein.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method comprising:
displaying, on a device display of a mobile device, by at least one data processor executing a display engine, a graphical user interface comprising a first set of user-input elements capable of receiving user input defining a command to be performed by the mobile device;
receiving, by the at least one data processor executing the display engine, sensor data from at least one sensor operatively connected to the mobile device, the sensor data corresponding to a user motion detected by the at least one sensor;
determining, by the at least one data processor executing the display engine and based on the received sensor data, a second set of user-input elements to display on the graphical user interface; and
displaying, by the at least one data processor executing the display engine, the second set of user-input elements on the graphical user interface.

2. The computer-implemented method of claim 1, wherein the received sensor data is based on a device motion detected by the at least one sensor and corresponding to the user motion.

3. The computer-implemented method of claim 2, wherein the device motion comprises a rotational motion corresponding to a device rotation about an axis.

4. The computer implemented method of claim 3, wherein the device motion further comprises an angular acceleration about the axis; and
wherein the determining is further based on a value of the angular acceleration, determined from the received sensor data, exceeding a predetermined threshold.

5. The computer implemented method of claim 4, wherein the mobile device is a wearable device worn by a user.

6. The computer implemented method of claim 5, wherein the wearable device is a smart watch worn on a wrist of the user and the axis is proximate to a center of the wrist and substantially parallel with a forearm of a user.

7. The computer-implemented method of claim 1, further comprising:
receiving, by the display engine via the graphical user interface, first input data corresponding to a lateral motion performed by the user interacting with the device display; and
translating, in a lateral direction on the device display and by the display engine, a current set of user-input elements currently displayed on the graphical user interface to display an updated set of user-input elements.

8. The computer-implemented method of claim 1, wherein the second set of user-input elements displayed in the graphical user interface replaces the first set of user-input elements displayed in the graphical user interface.

9. The computer-implemented method of claim 1, wherein the first set of user-input elements and the second set of user-input elements are graphical elements corresponding to keys from a keyboard.

10. The computer-implemented method of claim 1, wherein the sensor is a camera and the user motion is a movement of an eye of a user that is imaged by the sensor data corresponding to the imaged movement.

11. A computer program product comprising a non-transient machine-readable medium storing instructions that, when executed by at least one programmable processor, cause the at least one programmable processor to perform operations comprising:
displaying, on a device display of a mobile device, by at least one data processor executing a display engine, a graphical user interface comprising a first set of user-input elements capable of receiving user input defining a command to be performed by the mobile device;
receiving, by the at least one data processor executing the display engine, sensor data from at least one sensor operatively connected to the mobile device, the sensor data capable of corresponding to a user motion detected by the at least one sensor;
determining, by the at least one data processor executing the display engine and based on the received sensor data, a second set of user-input elements to display on the graphical user interface; and
displaying, by the at least one data processor executing the display engine, the second set of user-input elements on the graphical user interface.

12. The computer program product of claim 10, wherein the received sensor data is based on a device motion detected by the at least one sensor and corresponding to the user motion.

13. The computer program product of claim 12, wherein the device motion comprises a rotational motion corresponding to a device rotation about an axis; and
wherein the mobile device is a wearable device worn by a user.

14. The computer program product of claim 13, wherein the device motion further comprises an angular acceleration about the axis; and
wherein the determining is further based on a value of the angular acceleration, determined from the received sensor data, exceeding a predetermined threshold.

15. A system comprising:
a programmable processor; and
a non-transient machine-readable medium storing instructions that, when executed by the processor, cause the at least one programmable processor to perform operations comprising:
displaying, on a device display of a mobile device, by at least one data processor executing a display engine, a graphical user interface comprising a first set of user-input elements capable of receiving user input defining a command to be performed by the mobile device;
receiving, by the at least one data processor executing the display engine, sensor data from at least one sensor operatively connected to the mobile device, the sensor data capable of corresponding to a user motion detected by the at least one sensor;
determining, by the at least one data processor executing the display engine and based on the received sensor data, a second set of user-input elements to display on the graphical user interface; and
displaying, by the at least one data processor executing the display engine, the second set of user-input elements on the graphical user interface.

16. The system of claim 15, wherein the received sensor data is based on a device motion detected by the at least one sensor and corresponding to the user motion.

17. The system of claim 16, wherein the device motion comprises a rotational motion corresponding to a device rotation about an axis; and
wherein the mobile device is a wearable device worn by a user.

18. The system of claim 17, wherein the device motion further comprises an angular acceleration about the axis; and
wherein the determining is further based on a value of the angular acceleration, determined from the received sensor data, exceeding a predetermined threshold.

19. The system of claim 17, wherein the wearable device is a smart watch worn on a wrist of the user and the axis is proximate to a center of the wrist and substantially parallel with a forearm of a user.

20. The system of claim 15, further comprising:
receiving, by the display engine via the graphical user interface, first input data corresponding to a lateral motion performed by the user interacting with the device display; and
translating, in a lateral direction on the device display and by the display engine, a current set of user-input elements currently displayed on the graphical user interface to display an updated set of user-input elements.
